(19) United States
(12) Patent Application Publication
(10) Pub. No.: US 2009/0097815 A1
(43) Pub. Date: Apr. 16, 2009

(54) SYSTEM AND METHOD FOR DISTRIBUTED AND PARALLEL VIDEO EDITING, TAGGING, AND INDEXING

(76) Inventors: Nils B. Lahr, Redmond, WA (US); Garrick Barr, Woodinville, WA (US)

Correspondence Address: BLACK LOWE & GRAHAM, PLLC, 701 FIFTH AVENUE, SUITE 4800, SEATTLE, WA, 98104, US

(21) Appl. No.: 12/141,719

(22) Filed: Jun. 18, 2008

Related U.S. Application Data
(60) Provisional application No. 60/944,765, filed on Jun. 18, 2007.
(60) Provisional application No. 60/952,514, filed on Jul. 27, 2007.
(60) Provisional application No. 60/952,528, filed on Jul. 27, 2007.

(51) Int. Cl. H04N 5/93

(52) U.S. Cl. 386/52; 386/E05.001

(57) ABSTRACT

A system and method for having a media engine, client, workflow engine and server. The media engine takes digital or analog real-time video or video-on-demand as an input. Clients connect to the media engine, workflow engine and server. Depending on the client's capabilities, including software features, training and location, the workflow engine will drive required units of work to the client asking them to be fulfilled. This system enables efficient offline, real-time or faster than real-time editing, tagging and indexing of media by one or more clients at the same time. Unlimited numbers of users, tags and indexing functions to take place in parallel on a single video feed at the same time and managed through a rule based workflow engine.

### CROSS REFERENCE TO RELATED APPLICATIONS

The application claims priority to and incorporates by reference in their entirety herein U.S. Provisional Application Nos. 60/944,765 filed Jun. 18, 2007; 60/952,514 filed Jul. 27, 2007; and 60/952,528 filed Jul. 27, 2007.

### FIELD OF THE INVENTION

The field relates to broadcast quality digital video editing of present and historic event data files.

### BACKGROUND OF THE INVENTION

Annotation of presently acquired or historically presented broadcast files require dedicated personnel occupying computer monitors to enter annotated descriptions relative to portions of the broadcast files. The timely merging of the human-sourced annotations with the broadcast files, especially when the broadcast is of a live or currently happening event, has presented problems for the broadcast business. Current solutions used by broadcasters include manipulating high bitrate digital video where the human controls are located directly at the device used to perform the editing. Additionally, the visual component of these current systems, which allow for the user to annotate and review elements such of defined beginning and end points of various segments of a broadcast, encompass a TV screen or high definition television for rendering of the video being edited. A TV station, movie production or other traditional broadcaster today only has a few real-time video feeds at a time.

### SUMMARY OF THE PARTICULAR EMBODIMENTS

A system and method of using a media flow engine in communication with one or more clients, a workflow service and a media distribution service to perform digital video editing using post production functions substantially implemented in near real-time of presently acquired or historic information files. The systems and methods allow for efficient editing of multiple video or other information feed formats at substantially the same time without requiring local access or commanding high bitrates between the editing controls and the high quality video or other information format feed itself.

### BRIEF DESCRIPTION OF THE DRAWINGS

Embodiments of the present invention are described in detail below with reference to the following drawing.

FIG. 1 pictographically illustrates a system broadcast of a delayed and incompletely annotated transmission;

FIG. 2 pictographically illustrates an embodiment of a distributed annotation system implemented remotely from a sporting event venue configured to provide content rich annotations;

FIG. 3 schematically and pictographically depicts a flow process for broadcast content annotation;

FIG. 4 schematically illustrates a media flow engine algorithm 100 having a sub-algorithm 200 medium engine and a sub-algorithm 300 workflow engine;

FIG. 5A schematically illustrates an expansion of a media flow algorithm 100;

FIG. 5B schematically illustrates an expansion of the Media Engine algorithm 200 of FIG. 5A;

FIG. 5C schematically illustrates an expansion of the Workflow Engine algorithm 300 of FIG. 5A;

FIG. 6 schematically illustrates an expansion of the receive-and-allocate tasks block 108 of FIG. 5A;

FIG. 7 schematically illustrates an expansion of the source selection block 116 of FIG. 5A;

FIG. 8 schematically illustrates an expansion of the client queuing block 128 of FIG. 5A;

FIG. 9 schematically illustrates an expansion of the encorder queuing block 120 of FIG. 5A;

FIG. 10 schematically illustrates an expansion of the video and data encoding block 132 of FIG. 5A;

FIGS. 11-21 depict various screenshots used in executing or resulting from the algorithms described in FIGS. 4-10;

FIG. 22 schematically depicts an Owner Annotation algorithm; and

FIG. 23 schematically depicts a Proxy Entity Annotation algorithm.

### DETAILED DESCRIPTION OF THE PARTICULAR EMBODIMENTS

In general, the particular embodiments include systems and/or methods to perform efficient human originated annotation and/or subsequent computer based editing of the human-originated annotation files to incoming information file feeds received from multiple sources, and to do the annotation and revisions thereto at substantially the same time the incoming information file feeds are received without requiring local access or high bitrates between the editing controls and the sources of the information file feeds. The systems include multiple clients in communication with a server that utilizes a media flow algorithm engine accessible by the multiple clients and the server to allow a plurality of distributed human annotators to originate annotation files to the incoming information feed or feeds, including live broadcast audio-video files and historic files received from database archives. The incoming feed or feeds, if originally provided as an analog signal, may be converted to a digital format and optionally trans-coded to other digital formats prior to human-annotation and any subsequent computer-based modification of the human sourced annotation files.

The media flow algorithm enables human generated and computer edited annotation files of present and/or historic events to be remotely distributed from the remotely located clients to the server. The media flow algorithm is approximately partitioned into a media engine algorithm and a workflow engine algorithm. The media engine algorithm communicates with one or more clients, and the workflow engine provides a distribution service configured to perform digital video editing using post-production functions substantially implemented in near real-time to a presently broadcasted event. The algorithmic methods described herein employ distributed and parallel video editing, tagging and/or indexing from multiple client annotators who provide autonomously generated and/or hierarchally generated annotation files that may be further edited by computer implemented processes relating to present and/or historic events for delivery to the server, or optionally, within the server architecture.

The human sourced annotation files to the present and/or historic events may be subsequently transcoded or revised prior to receipt by the server and/or within the server after delivery. Occupying remote client locations, the human annotators utilize the media flow engine to deliver the human-annotated files and any subsequent computer-based modifications to the server.

Other embodiments of the media engine include acquiring digital or analog real-time video inputs received by one or more client human annotators to connect and control an individual input. Each client-annotator is registered with a workflow service that has knowledge of the functions that a given client-annotator can perform both technically as well as what functions the human client-annotator has been certified for. Clients can subscribe to a live source or select a media on demand file, for example a video-on-demand (VOD) file and receive a reduced bitrate version across the network. Once subscribed, these human-annotators can perform typical editing functions such as setting time-in and time-out points, or beginning time point and ending time point of a given segment of the VOD files, and provide annotation information that may be viewed by a VOD broadcast receiver or reside as attached metadata to the video which can be indexed later. Other client-human annotators can subscribe and the workflow engine will recognize their capabilities and assign other work, for example, provide a higher bitrate version of only the video between the in and out points generated by the first client working on the live feed. There is virtually no limit to the number of clients or complexity of the workflow platform such that near limitless indexing of a video source may be achieved simply by increasing the workflow model and making sure there are enough client-human annotators logged into the system to match the demand.

The client can perform operations such as changing the channel when there is a standard receiver connected to the media engine input, play, pause, fast forward and rewind. The media engine can be configured to perform some otherwise client only functions such as auto detection of commercials, utilization of broadcast tones or performing algorithmic analysis of the video itself. Thumbnails or low quality versions of the source can be created at the same time and presented to the client. With the thumbnails, the client can determine quickly what portions of the source contain meaningful content without having to review the video in real-time or download and watch the video associated with the thumbnails. This dramatically reduces the amount of data the client requires to perform its required operations, as it will only receive relevant content to be edited further. Once a portion of the video source is marked as relevant to the current editing process, this data will be sent, again in reduced quality and bitrate, to the client. The client can then perform non-linear editing functions on the selected video, such as setting multiple in and out points. This system can also be used for editing of video-on-demand files rather than a live video source, where the media engine can use a media file as its input rather than a live analog or digital feed. Regardless of the format of the input, this system enables efficient offline or real-time editing of media utilizing a complex automated workflow system which in turn allows for the divide and conquer strategy to be used with regards to the various steps required to edit, tag and index video. The workflow engine knows what work needs to be accomplished and breaks down the work into units based on known policies specific to the work type. It will then farm out each unit of work to connected clients in an optimized way as to ensure the work is accomplished as fast as possible by clients that are qualified to perform each unit of work. This allows for high speed editing and tagging of video in parallel and distributed across multiple users and/or automated systems at the same time.

Other system embodiments include a media engine, for importing analog or digital media in real-time or directly from a digital video source, such as a file, and to transcode the input to multiple output formats, such as multi-profile streaming formats like windows media or mpeg4, as well as image file in varying sizes. This element can transcode into each required output format automatically, while it also stores a high quality version of the input for later use. Transcoding can take place in faster than real-time when using video-on-demand files and in real-time on live feeds. A client or annotator can request a portion of any stored media to be transcoded at a later date and sent to the server based on specific request parameters.

Operating with the media engine is a server, for serving various media elements that have been produced by the media engine. Additionally, a client may upload media directly to the server for later consumption by other clients. The server has information that ties various media elements together such that a connected client can understand which images match which video segment, when they were captured, and other such critical data relationships about all media stored on the server, operationally connected to said media engine, remotely connected to said media engine.

In communication with the server is a client, for enabling the control of the media engine and viewing of media through the server. By communication with both of these elements, the client can review images and/or various media profiles and allow the user to perform commands such as fast forward and play while also setting in and out points on media existing on the server. Commands can be sent to the media engine to create new media elements from its archive of high quality video it has stored, operationally connected to said server, and operationally connected to said media engine, remotely connected to said media engine. The client also communicates with the workflow engine which enables and disables specific capabilities of the client based on what unit of work is being performed as well as system preferences such as user location, experience level and current bandwidth throughput.

Yet other embodiments of the system include a tuner device, for representing digital video input to the media engine. Digital video sources include VOD (video-on-demand) files and already digitized video such as h.264. The output of the media engine can be digital video, both live and stored, so these can also be used as digital video inputs if requested by the client, operationally connected to said media engine, locally connected to said media engine. Working in concert with the tuner device, media engine, and server is a workflow engine. The workflow engine manages the supply and demand of the entire digital video editing, tagging and indexing process across automated and/or user driven clients.

In yet other embodiments the disclosure below includes a system for video editing having a media engine to import at least one of an analog media and a digital media to transcode the analog and digital media to form a transcoded media file, utilizing a server for receiving the transcoded media file, utilizing an annotation service available to annotate at least a portion of the transcoded media file and a workflow engine utilizable by the annotation service to annotate the portion of the transcoded media file to form an annotated media file. Other system embodiments include the annotated media file being storable on the server or other servers, accessible by the public, and viewable by the public.

Other embodiments disclosed below include a method for video editing having a procedure of importing at least one of an analog and a digital media from a video source, transcoding the at least one analog and at least one digital media to form a transcoded media, acquiring an annotation service, uploading the transcoded media to a server, reviewing the transcoded media on a client device, for example a personal computer, reviewing the transcoded media on the client device, and annotating at least a portion of the transcoded media using the annotation service. Other method embodiments include the annotated media file or the annotated transcoded media being storable on the server or other servers, accessible by the public, and viewable by the public.

A complete understanding of the present invention may be obtained by reference to the accompanying drawings, when considered in conjunction with the particular and alternate embodiments described below.

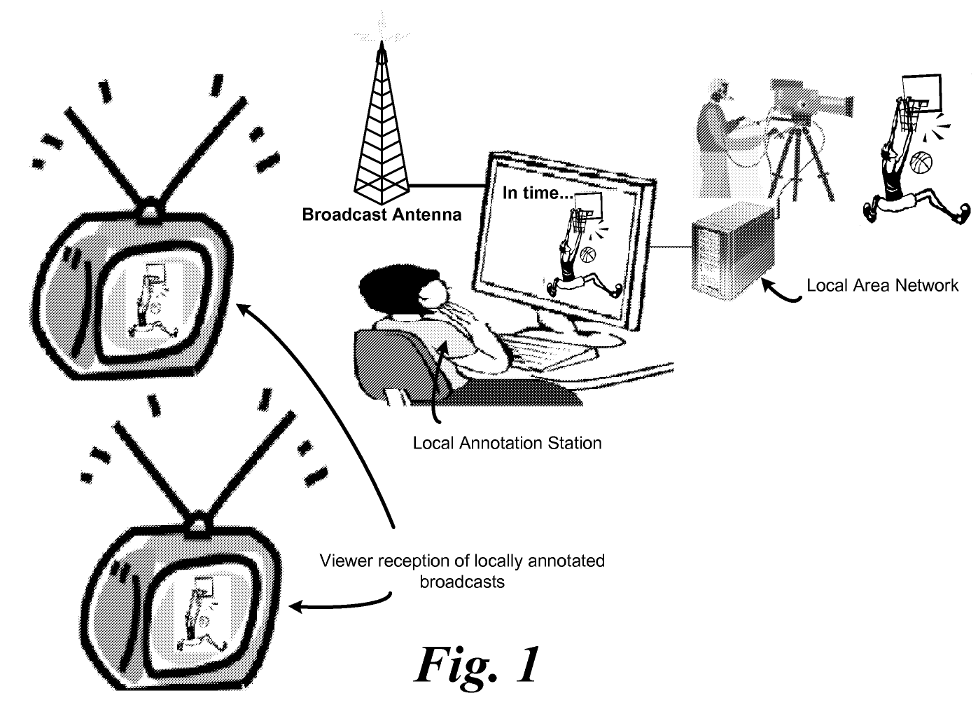

FIG. 1 pictographically illustrates a system broadcast of a delayed and incompletely annotated transmission. The scenario depicted is of a local “live” sporting event, depicted here of a basketball player making a “stuff” shot, in which image acquisition via a camera are sent to a local or on-site low-level annotation service via a communication link from a local arena network having approximately a 1-gigabyte capacity. Analog or digital acquired images are routed through an encorder and made available to an on-site annotator. The local or on-site annotator works at an annotation station and provides low information content to the analog or digitally acquired images. Here, a cameraman acquires images of a basketball player. The locally acquire image files are sent to a human annotator within an approximate high capacity 1 gigabyte local area network (LAN) in which the analog, or digital files, are routed through an encorder via the LAN, or alternatively via the Internet. Located courtside or in a nearby facility, and basic annotations are entered at the annotator's local computer station equipped with only the basic digital video recorder (DVR) functions. Annotation by the courtside annotator is limited to single sport events and the annotation is often sub-standard and hours late after the “live” sporting event. Annotated images are readied for re-broadcast via the antenna and viewer televisions receive the delayed and low-information content annotated broadcast files. The “live” broadcast is far from it since broadcast delay may be as late as two hours from the time undertaken to acquire the original sporting event images. Delayed broadcasts presented on the viewer televisions have incomplete or low information content annotations.

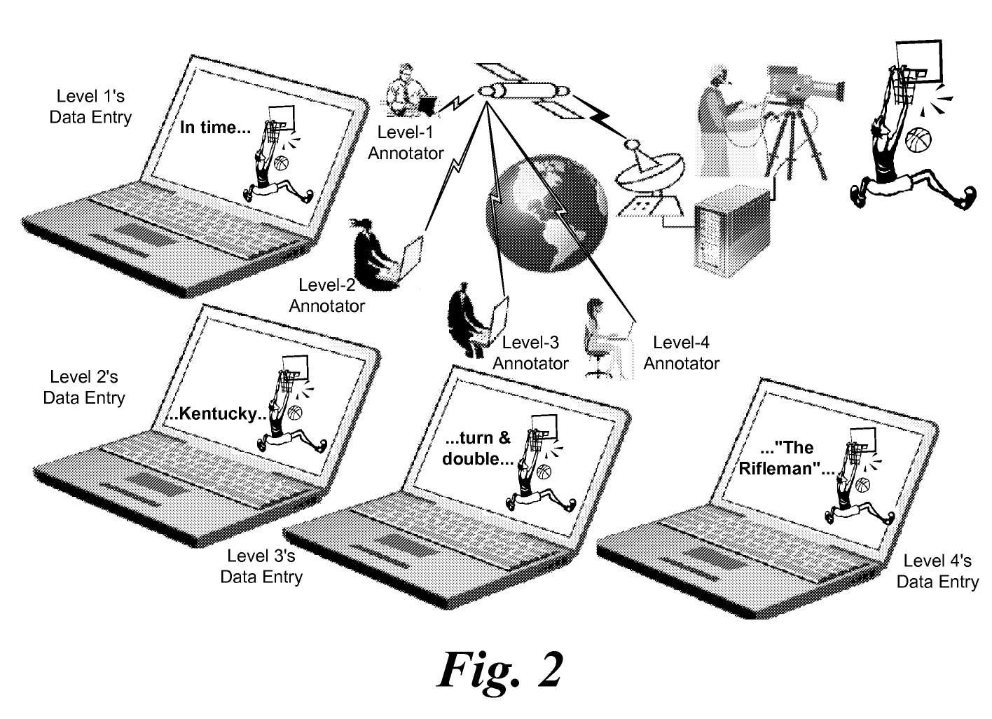

FIG. 2 pictographically illustrates an embodiment of a distributed annotation system implemented remotely from a sporting event venue configured to provide content rich annotations. Here image acquisition of a local “live” sporting event is conveyed by communication uplink for remote site annotation and delivered as “live” event feeds to an annotator labor poll distributed remotely to annotators having different task level assignments, depicted here a levels 1-4 annotators. The level 1-4 annotators may uplink for delivery of annotated data files for broadcast of live or historic annotated data files having annotations with content-rich information provided with a minimum time delay relative to the time the broadcast event was received by the level 1-4 annotators to provide their respective annotation services. Images acquired by local or “live” sporting event, in this case an image series of the basketball player stuffing or making a basket, are readied for a communication uplink to be delivered to multiple and remotely located sites for high information content annotation. The uploaded image signals are globally distributed to an on-call annotator labor pool that is remotely distributed or geographically diverse from the local sporting event site. The annotator labor pool is ready to provide annotation services to “live” broadcast or any broadcast source, from databases or other computer readable media, for example a digital video disk (DVD). The broadcast signals of live or archived events receivable by the annotator labor pool may be conveyed to the receiving annotators in high, medium, and/or low or otherwise reduced bitrate signal deliveries. The annotator labor pool is categorized to provide different annotation service levels or task levels. Here the annotator pool receives incoming digital-based files for annotation, including audio-video files, here conveyed by wireless transmission from a satellite. Alternatively, the incoming audio-video files may be received by wired or cabled networks, including the Internet.

In this depiction, the annotation labor pool is categorized into four task levels comprising a level-1 annotator, a level-2 annotator, a level-3 annotator, and level-4 annotator, each having a computer to implement annotation services. Other task level increments less than or greater than four may be categorized. Here the level 1-4 annotators are geographically spread out globally. The digital files are received by the levels 1-4 annotators, and each annotator inputs data entry relevant to the images appearing in the broadcast-in this example the basketball player making the stuff shot. At the level-1 annotators station, the level-1 annotator inserts the possession time or the in-time and the out-time the player had possession of the ball that is associable to the broadcast or game clock time. In this case the Level-1's annotation may read “time-in is 13.8 seconds and time-out is 17.5 seconds”. To this same annotation time frame, the Level-2's annotation is inputted to read “Pistol Pete's basket was made from execution of an Indiana Weave”. To this same annotation the Level-3's annotation is inputted and reads, for example, “Pete's basket made overcoming a 2-1-2 Strong Side Combination Defense” or “Pete's basket made overcoming a Turn and Double Man-to-Man Defense”. The Level-4 annotator may be assigned to add sports specific strategic or tactical annotations, or may provide “color” commentary to augment the richness of the annotation information content of the broadcast. For example, the Level-4 annotator might input an annotation that reads “Pete stuffed that basket and almost shattered the backboard like Chuck “The Rifleman” Connors did in the first Boston Celtics home game in 1947”. Each Levels 1-4 annotation then can be uplinked back to the broadcast facility for near instantaneous broadcast of the locally acquired sporting event.

Referring still to FIG. 2, the globally dispersed annotators, also referred to as clients, receive their respective files for annotation under indeterministic bandwidth have more feature rich DVR capability. DVR features include auto restarting. The bandwidth offers resilient connection, and the ability to engage multiple profile switching between level 1-4 annotators with the annotation labor pool, establishing a very fluid and adaptable editing workflow foundation. The labor pool having the level 1-4 annotators may announce their respective on-call global announcements utilizing ontology logging. Upon logging in ontologically, the media and workflow engines described below are primed to provide to the logged on level 1-4 annotators the event schedules, the computer resources, the event work available in queue, and the ability to match level 1-4 annotators in a phase relationship with the given tasks for a given digital file queued for annotation, and to store and map the communication connections to the level 1-4 annotators in the event re-routing contact to each annotator is required should communication interruptions occur. That is, the level 1-4 annotator's skill sets need not be mutually exclusive, but instead be bridged with skill repertoires having subsets with matching elements common to levels 1, 2, 3, and 4.

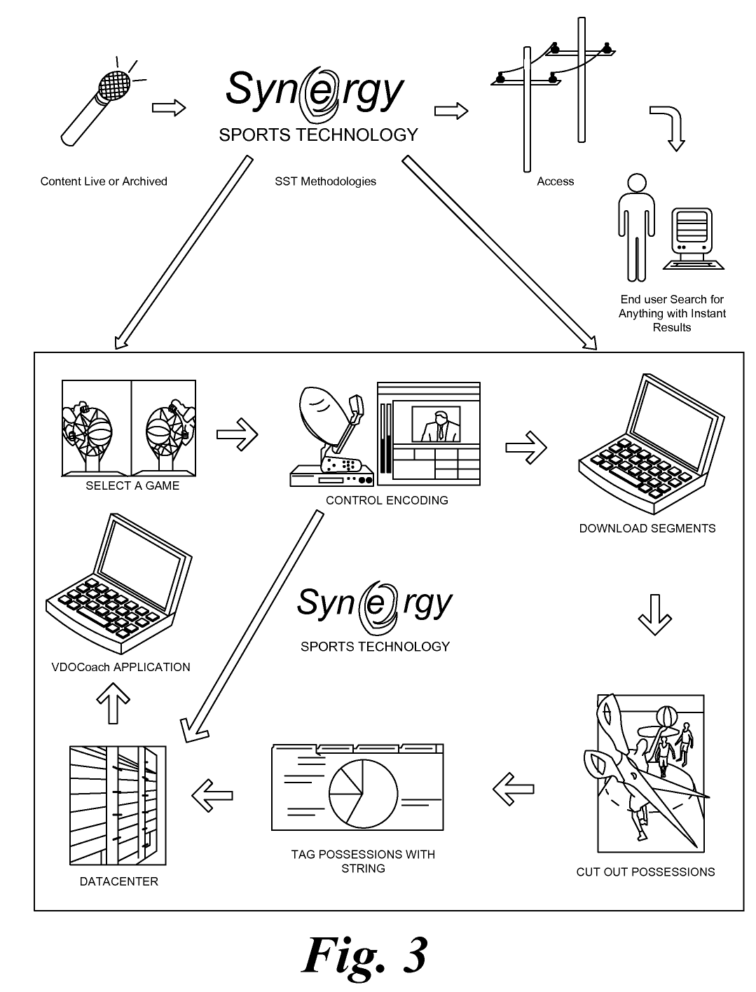

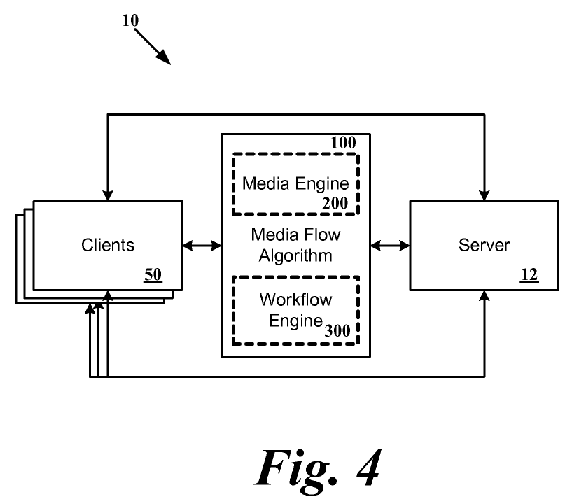

FIG. 3 schematically and pictographically depicts a flow process for broadcast content annotation. Using the Media Engine and Work Flow Engine described below, annotation processing illustrate different examples of how the Level 1-4 annotators are able to achieve near-simultaneous annotation. Content acquired “live or archived” is channeled to the Synergy™ SST Methodology based software, processed through the SST, conveyed to low and high bandwidth communications, and made available to a broadcast recipient or end-user equipped to view or search within the annotated files associated with the user-received broadcast.

The flow diagram of FIG. 3 employs SST Methodologies where “Cut Out Possessions” is categorized as Phase I or Level-1 annotation and “Tag Possessions” is another example of a Phase I of Level-1 annotation where a given audio and/or audio-video file is tagged with a series of annotation strings. The SST Methodologies utilized by level 1-4 annotators include pressing an interface button “select a game”. The selected game is then routed to an encorder, and encoded segments are downloaded for annotation. The encoded segments are received by the assigned level 1-4 annotators. Annotaton results ends up at the data center and the “VDOCoach Application” is what the annotators utilize to further edit or make relevant commentary for a given task level annotation assignment.

FIG. 4 schematically illustrates a block diagram of a system 10 for distributed and parallel video editing, tagging, and indexing between a server 12 and a plurality of client annotators 50 via a media flow engine 100. Integral with the media flow engine 100 is a medium engine 200 and a workflow engine 300 in two way communication with the server 12, and the plurality of client annotators 50. The server 12 and client annotators 50 are in iterative contact with each other through the media flow engine 100.

The system 10 receives or ingests media sources, transcodes the media into multiple different output profile and formats, serving this output and keeping track of media associations. The client can then control the media engine as well as create and add new metadata that can be used to identify each media element and tie media elements into groups.

The relationships between the entities or components of the system 1 described in FIG. 4 may be varied. It is possible that one or more of these components exist within the same process and/or machine. The media engine 10 ingests analog or digital video in either real-time or as video-on-demand files. It stores a high quality version of the file for a specified period of time such that future commands from a given annotator level 1-4 client 50 to better perform actions such as clipping elements from a larger media file and creating new smaller media files. The media engine 10 can transcode incoming media into multiple outputs and send these to the server 12 element. Along with the media, the media engine 10 tags the media with metadata such as when it was created, keywords and other relevant data specific to the video being captured. The server 12 element keeps track of the media and the metadata such that a given client-annotator 50 can use the metadata to search for required media elements and associate, for example, what images were captured and from what original video source. The client-annotator 50 can send commands to the media engine 200 to control the input video feeds, such as changing channels on a tuner device, or select a video file or live feed to perform editing functions on as a digital video source. The client-annotator 50 can use information from the server 12, such as low bitrate images, to perform actions with the media engine 200, such as “create a new video asset that starts at image x and ends at image y and output the result as a multi-bitrate multi-profile streaming media file”. The workflow engine 300 manages what each connected client-annotator 50 can accomplish based on, for example, workflow definitions, user experience levels, current bandwidth throughput and location. The entire process enables multiple clients to address units of work from one or more video sources effectively enabling parallel processing of unlimited video sources at faster than real-time speeds.

Since other modifications and changes varied to fit particular operating requirements and environments will be apparent to those skilled in the art, the invention is not considered limited to the example chosen for purposes of disclosure, and covers all changes and modifications which do not constitute departures from the true spirit and scope of this invention.

The system 10 utilizes methods for distributed video editing, tagging and indexing for breaking down these tasks into the smallest unit of work and enabling unlimited simultaneous users with varying bandwidth links to be driven by a dynamic workflow system that includes: the media engine 10, for importing analog or digital media in real-time or directly from a digital video source, such as a file, and to transcode the input to multiple output formats, such as multi-profile streaming formats like windows media or mpeg4, as well as image file in varying sizes. This element can transcode into each required output format automatically, while it also stores a high quality version of the input for later use. Transcoding can take place in faster than real-time when using video-on-demand files and in real-time on live feeds; the client or clients 14 that can request a portion of any stored media to be transcoded at a later date and sent to the server based on specific request parameters; the server 12, configured for serving various media elements that have been produced by the media engine. Additionally, a client or client-annotator 50 may upload media directly to the server for later consumption by other clients. The server 12 may also have information that ties various media elements together such that a connected client can understand which images match which video segment, when they were captured, and other such critical data relationships about all media stored on the server, operationally connected to said media engine, remotely connected to said media engine; the client or client(s)-annotator(s) 50 enable the control of the media engine and viewing of media through the server. By communication with both of these elements, the client-annotator 50 can review images and/or various media profiles and allow the user to perform commands such as fast forward and play while also setting in and out points on media existing on the server. Commands can be sent to the media engine to create new media elements from its archive of high quality video it has stored, operationally connected to the server, and operationally connected to the media engine, remotely connected to said media engine. The client also communicates with the workflow engine which enables and disables specific capabilities of the client based on what unit of work is being performed as well as system preferences such as user location, experience level and current bandwidth throughput; a tuner device (not shown), for representing digital video input to the media engine. Digital video sources include VOD (video-on-demand) files and already digitized video such as h.264. The output of the media engine can be digital video, both live and stored, so these can also be used as digital video inputs if requested by the client, operationally connected to said media engine, locally connected to the media engine; and the workflow engine 18, for managing the supply and demand of the entire digital video editing, tagging and indexing process across automated and/or user driven clients.

The system 10 and methods used by the system 10 described in FIG. 4 provide for real-time and near real-time editing beyond what is typically used in current systems to switch between camera angles and splice in commercials or other supporting media. These current systems require on-site editing systems that have sub-second delays and a local human operator to monitor and maintain its functioning at all times. After editing a video source, there are additional challenges in adding metadata tags to allow for indexing the content of the media which in turn enables complex contextual searches.

Until today, having sub-second real-time production quality editing has been good enough to produce the content required by today's video distribution systems, such as cable and satellite TV. However, the consumer-based video distribution systems are being revolutionized with the introductions of solutions that are bi-directional digital video solutions, giving the consumer a fully interactive application-based experience within their TV service. Examples of these are Microsoft's IPTV and Comcast's Coax services which provide functions such as pause, play, rewind, video-on-demand, games and other fully interactive features. Additionally, the Internet enables consumers to have many of the same functions on their computer as they do with their TV service.

Video content for these new systems comes currently in two forms, the traditional real-time video with perhaps some additional features such as changing camera angles or having hot key data within the broadcast and video-on-demand, such as pay-per-view movies or playback of video assets per user and on demand. Applications are being developed to provide instant highlights of a sporting event as well as interactive immersion applications allowing movies to have multiple endings or commercials to provide direct ordering capabilities. However, there are no editing, tagging and indexing platforms which enable the best computer in the world, the human brain, to scale cheaply while still performing these functions on an unlimited number of real-time or video-on-demand feeds at the same time.

There are systems that use subtitles and basic computer algorithms to automate tagging of video, but these are overly basic and the resulting indexed data is not valuable. Searching video based on these methods of tagging does not bring a new richness to the user because the automated data feeds do not provide valuable indices. Viewing when a newscaster spoke the word “Clinton” or repeating all of the “Slam Dunks” of a basketball game has proven interesting but not highly valuable. For each genre of video, such as sports or news, there is a set of valuable tags, such as what hand was used to make a shot or the context of the news story relative to other top issues of the day. Furthermore, tags can be defined in an hierarchical manner providing relationships between tags which can later be utilized more effectively than tags that stand alone. Some systems allow for simplistic tagging and indexing of video but there are no solutions that enable complex metadata tagging against near real-time, real-time or faster than real-time video inputs.

Current digital video editing solutions that take an analog or digital input, have a special console allowing for functions such as fast forward, rewind, pause and set in or out points. Some of these devices are applications that run on fast computer systems, while others are embedded systems providing specific real-time editing functions such as switching input signals, inserting commercials and performing fades and wipes. These systems are considered real-time video production systems. Other systems are used for post production functions, such as preparing video for archival and cutting and pasting different video clips together.

None of today's solutions allow for digital video editing where many of the post production functions can be implemented in near real-time or faster than real time as described for FIG. 4. Either they provide live output to be used for live broadcasting, or they provide completely offline editing where timing is not a critical issue. If, during a presidential speech, a consumer would like to review all of the times Bush said something about health care, current solutions allow for some basic real time tagging but the tags are non-relational and slow. This means the number of tags per hour is limited to a fraction of the tags that would be required to fully tag all of the critical areas of the video. Additionally these solutions do not enable multiple systems, human and/or computerized, to work together based on a workflow definition. Today's systems allow each user to slowly edit and tag the video source but do not share this data in real time with others performing the same work, nor do they know if their tags are additive, redundant or standardized. Essentially today's solutions do not scale beyond how fast a single user can edit the incoming video feed.

Current real-time digital editing solutions assume that one person is responsible for the entire editing workflow, from ingest through to producing assets. This is because the tools are designed as a single application making it cumbersome. For example, one person to cut the video, another to make modifications, another to tag and index and another to collate the results into the required asset for the broadcast. It is easier for a single person to be responsible for this work than to split up the work as then the verbal communications alone more than doubles the time it takes to get the job done. This also assumes that it is possible to communicate effectively between the workers and that the video is accessible to everyone at the same time. Verbal communications is not an effective means of scaling the process of editing, tagging and indexing video. Even still it is common in today's advanced studios to see intercom systems installed to enable some level of free form workflow to occur but these solutions are highly inefficient and do not scale well beyond handling a single studio channel.

The problems described here are increasing quickly. The broadcasters don't have the economic reasons yet to implement costly methods of generating ready-for-interactive-TV content, while they also don't have solutions that would provide them the capability of using their current linear video as input to the newly deployed interactive TV systems. Also, as the Internet grows, it is becoming another conduit for publishing interactive content, but most broadcasters are still not able to repurpose their linear content in a text and/or media format that would drive a business model sufficient to support a significant return on their investment without unacceptable and unclear risks. However, IPTV is being deployed and is expected to become the next generation media delivery method to the home. The Internet and computers are creating huge revenue opportunities for content delivered where and when it is asked for. Additionally, new business models are being generated almost yearly around rich metadata and/or media, such as fantasy sports and online subscription services. What is required to solve this problem is a method and system that can economically provide near real-time editing, tagging and indexing to large amounts of content such that the output can be used to drive next generation interactive applications

Alternate embodiments include the media engine configured to convert video-on-demand files from their current format into the digital format required by the system, and to output the digital formats into multiple digital and still image versions of an input source.

Other embodiments provide for a media engine that can receive real-time or file based metadata for the input video for use by connecting clients and a server that hosts the metadata for the various associated media elements. The client may communicate with the server and the media engine and may review individual media elements through real-time delivery or download and view locally. The client may also be configured to be driven by a central workflow system and have features optimized based on the qualifications of the user.

Yet other particular embodiments provide for a client that can receive metadata associated with incoming media and allows the client to attach units of the data to specific points or time ranges of the associated video. Other particular embodiments provide for a workflow engine that enables dividing the tasks associated with editing, tagging and index video, and for other versions of the workflow engine configured to manage supply and demand in real-time based on matching video editing tasks with users online that are qualified to perform the required tasks.

The particular embodiments provide for applying complex automated workflow systems enabling unlimited number of simultaneous users the ability to edit the same video feed without repeating work performing by others as well as solving the issues related to performing such work over networks with bandwidth issues such as high latencies, low throughput, packet loss and indeterministic connect times. The present invention relates to faster than real-time, real-time, near real-time and video-on-demand editing, tagging and indexing of digital video regardless of the quality or bitrate of the source.

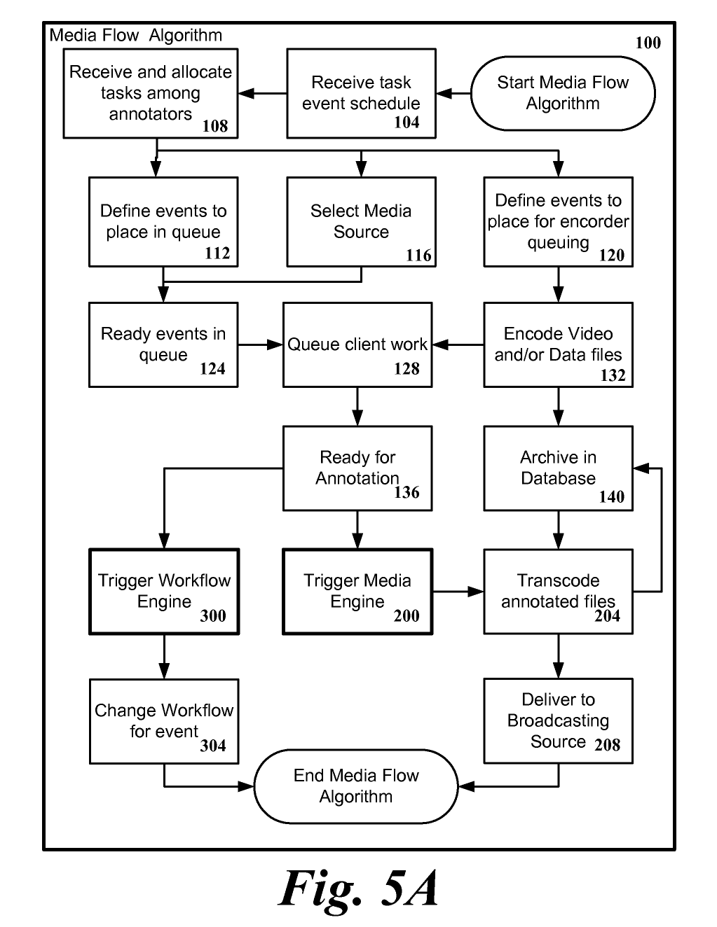

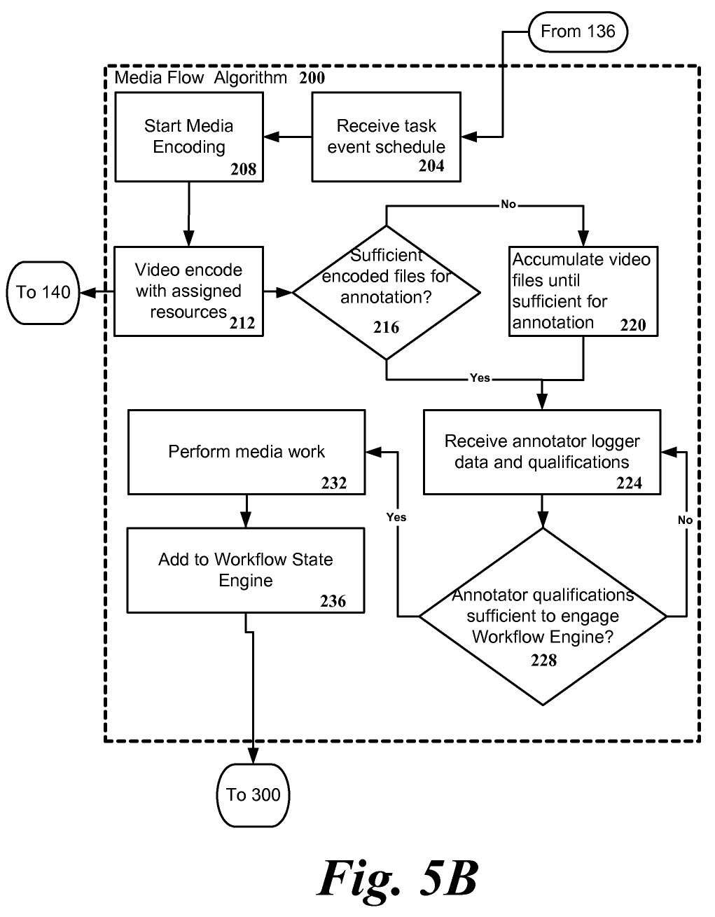

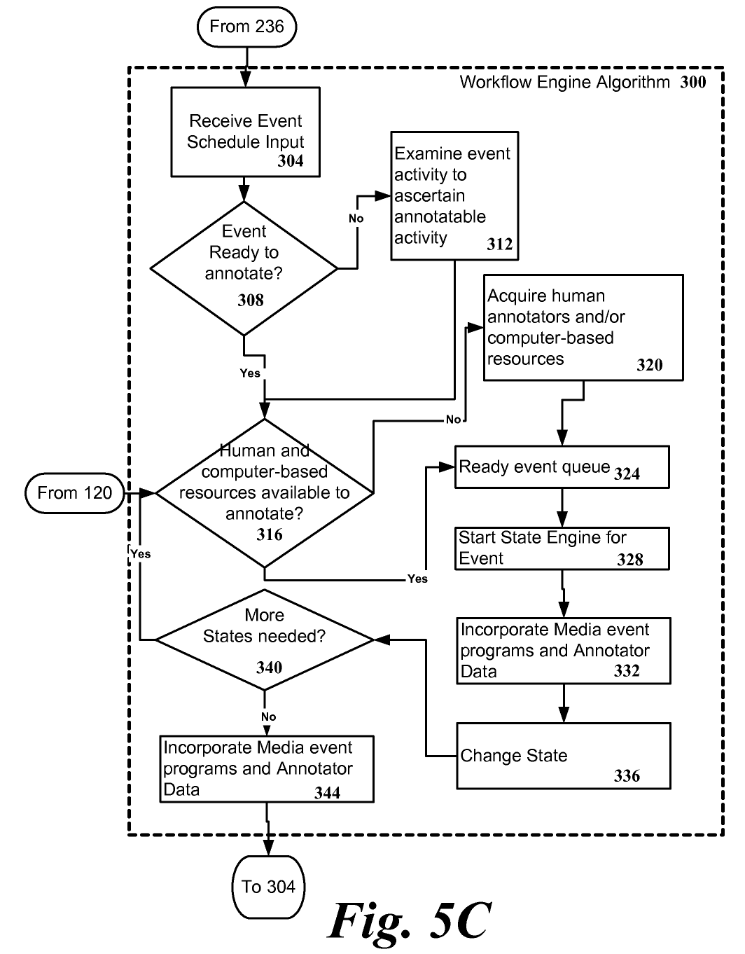

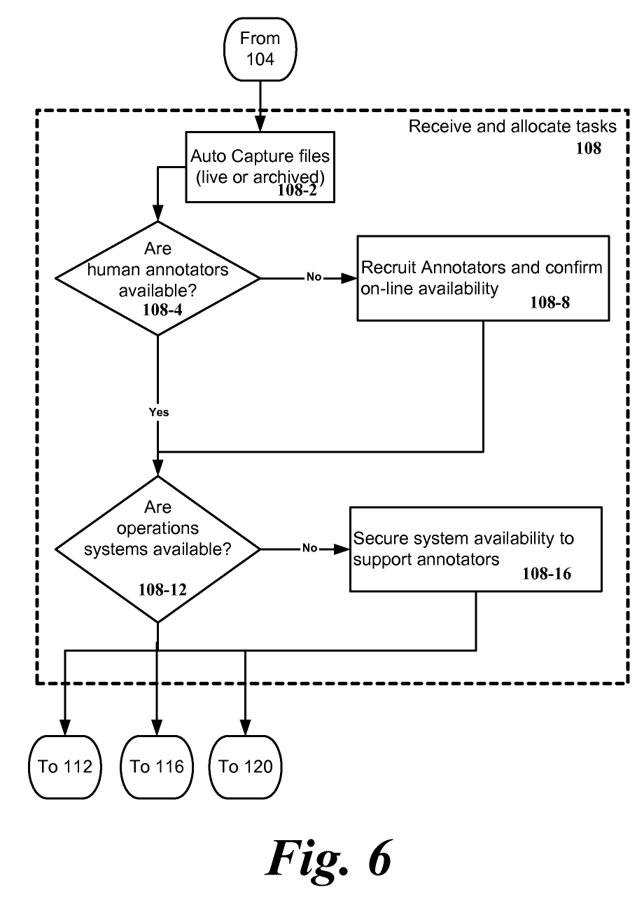

FIG. 5A schematically illustrates an expansion of a media flow algorithm 100. At process block 104, a task event schedule is received by the level 1-4 annotators, and then at receive-and-allocate tasks block 108 the received tasks are partitioned or classified according to task level assignments of the skilled annotator labor pool. The partitioning is classified into events defined for placement in queue at process block 112, a select media source at process block 116, and defining events to place for encorder queuing at process block 120. The events that are ready for encoding from process block 120 are encoded as video, audio-video, image, or other information based data files at process block 132. Process blocks 112 and 116 converge to ready event in queue at process block 124. Thereafter, at process block 128, the client work in queue is readied for work by the human annotators, either “live” broadcast events or encoded audio, video, or other information files received from process block 132. Annotation to the queued client work received by the level 1-4 annotators is completed and annotations outputted at process block 136. Thereafter, the Media Engine algorithm is triggered and process block 200 and the Workflow Engine is triggered at process block 300. Upon triggering the Media Engine Algorithm at process block 200, annotated files are either forwarded to the broadcaster for broadcasting at process block 208, and/or archived in database 140. Upon triggering the Workflow Engine Algorithm at process block 300, a change in the workflow is established for a given event at process block 304. Thereafter, the Media flow algorithm is finished.

FIG. 5B schematically illustrates an expansion of the Media Engine algorithm 200 of FIG. 5A. Entering from process block 136, tasks are received and scheduled at process block 204, and then media is encoded at block 2008. Thereafter, at process block 212, video is encoded with assigned resources. Output from process block may be stored in archival storage at process block 140 to exit Media Flow Algorithm 200, or alternatively, proceed to decision diamond 216 to ascertain whether “Encoded files are sufficient for annotation. If negative for sufficiency, then at process block 220 video files are accumulated until enough are gathered that is sufficient for annotation. If affirmative originally for sufficiency or made sufficient from an insufficient state, Media Engine algorithm 200 proceeds to process block 224 where annotator logger data and qualifications are received. Thereafter, at decision diamond 228, an answer is sought to the query “Are annotator's qualifications sufficient to engage Workflow Engine?” If negative, then process looks back to process block 224 to gather other annotators who have subsequently logged on and these new logons evaluated for their annotator level qualification. If affirmative for sufficient annotator qualifications, the process is routed to process block 232 to perform media work. Thereafter, at process block 236, the results of the performed media work is added to the Workflow State Engine and the Media Flow Algorithm 200 exits to the Workflow Engine Algorithm 300.

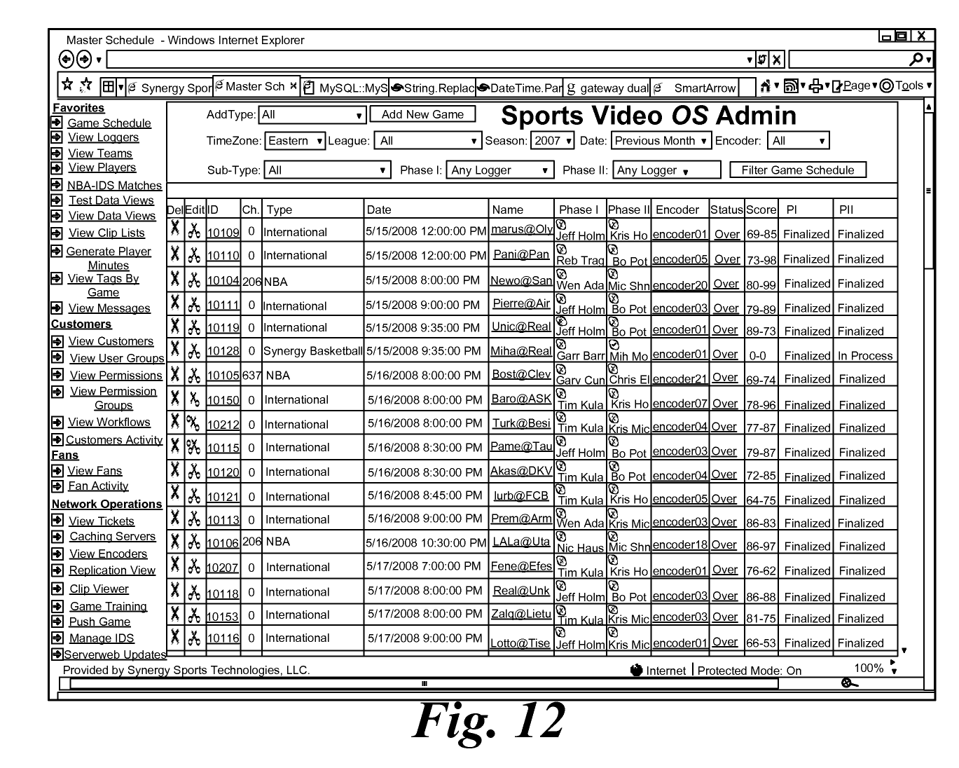

FIG. 5C schematically illustrates an expansion of the Workflow Engine algorithm 300 of FIG. 5A. Entering from process block 236, event schedules are received and inputted and may be presented in a series of screenshots to the annotator labor pool. Exemplary screenshots are provided in FIGS. 12-14. Thereafter, at decision diamond 308, an answer is sought to the query “Event ready to annotate?” If negative, at process block 312, the media files are examined for event activity to ascertain if an annotatable event or annotatable activity is present. If affirmative for whether the event is ready for annotation or that it is ascertained that an annotatable event is available, or if entering from process block 120 events for encorder queuing, then an answer is sought to the query “Are human and computer-based resources available to annotate?” at decision diamond 316. If negative, then at process block 320 human annotators from a trained labor pool and/or computer-based resources are acquired, and once acquired, are readied for queue at process block 324. If affirmative that human and computer-based resources are available to annotate, then these resources are similarly readied for queue at process block 324. Thereafter, at process block 328, the State Engine for the Event is started and Media and program events are incorporated along with Annotator provided data at process block 332. At process block 336, the state is changed and is followed by a query “More States needed”? at decision diamond 340. If affirmative, Workflow Engine Algorithm 300 re-routes to decision diamond 316, and if negative, routes to process block 344 where Annotator provided data and Media events are incorporated. The Workflow Engine Algorithm 300 then is completed and exits to process block 304.

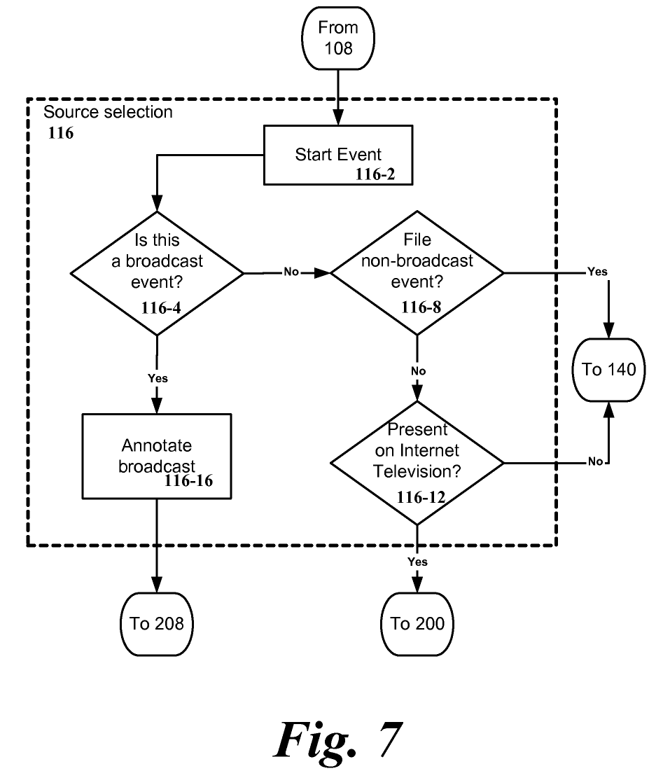

FIG. 6 schematically illustrates an expansion of the receive-and-allocate tasks block 108 of FIG. 5. Entering from process block 104, live or archived files are subjected to automatic capture at process block 108-2. Thereafter, at decision diamond 108-4, an answer is sought to the query “Are human annotators available?” If negative, then at process block 108-8, human annotators are recruited, trained as necessary to a given annotation level or skill repertoire set, and confirmed for on-line availability. If affirmative, then confirmation whether sufficient systems operations are available for the skilled annotator labor pool is queried at decision diamond 108-12. If not available, then at process block 108-16, sufficient systems are secured to service the available human annotator labor pool. If affirmative, to already sufficient or secured system sufficiency, then process block 108 exits to process blocks 112, 116, and 120.

FIG. 7 schematically illustrates an expansion of the source selection block 116 of FIG. 5. Entering from process block 108, media events are started at process block 116-2. Thereafter, at decision diamond 116-4, an answer is sought to the query “Is this a broadcast event?” If negative, another query, “File non-broadcast event” at decision diamond 116-8. If negative, then source selection block exits to process block 140. If affirmative that available data files are associated with a live broadcast, then the live broadcast is annotated by at least one member of the skilled annotator pool at process block 116-16 and process block 116 exits to process block 208. If negative for filing a non-broadcast event from decision diamond 116-8, then an answer is sought to the query “Present on Internet Television?” at decision diamond 116-12. If negative, then process block 116 exits to process block 140. If affirmative to presenting on Internet Television, process block 116 exits to process block 200.

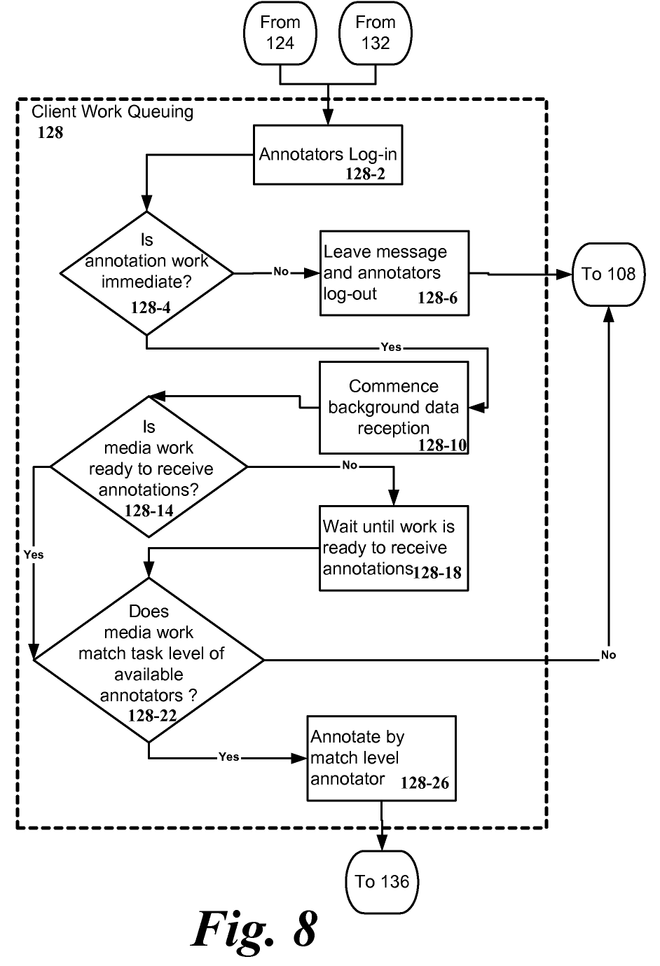

FIG. 8 schematically illustrates an expansion of the client queuing block 128 of FIG. 5. Entering from either process blocks 124 or 132, annotators log-in at process block 128-2 to announce availability of a working annotator labor pool. Thereafter, at decision diamond 128-4, an answer is sought to the query “Is annotation work immediate?” If negative, at process block 128-6, the logged-in annotators leave message and log-out to exit process block 128 and return to process block 108. If affirmative, then at process block 128-10, background data reception begins. The data reception includes collecting information from various sources, including file downloads and previous annotation files. Thereafter, at decision diamond 128-14, an answer is sought to the query “Is media work ready to receive annotations?” If negative, at process block 128-18, annotators wait until work is ready is in a format amenable to receive annotations from at least one member of the skilled annotation labor pool. If affirmative for work formats amenable to receive annotations, then at decision diamond 128-22, an answer is sought to the query “Does media work match task level of available annnotators?” If negative, process block 128 is finished and exits to process block 108. If affirmative, then at process block 128-26 annotations proceed by at least one member of the skilled annotator labor pool and process block 128 exits to process block 136.

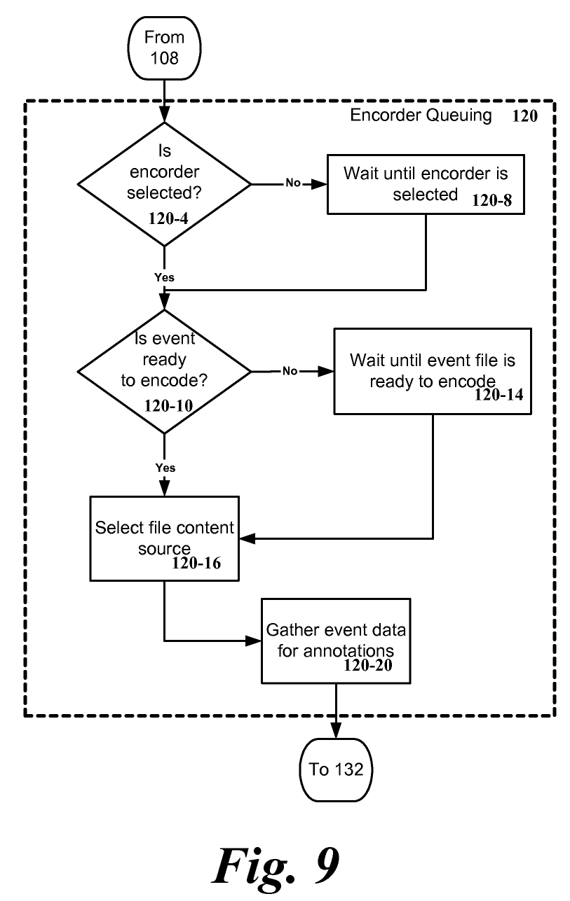

FIG. 9 schematically illustrates an expansion of the encorder queuing block 120 of FIG. 5. Entering from process block 108, an answer is sought to the query “Is encorder selected?” at decision diamond 120-4. If negative, the necessary waiting occurs until an encorder is selected at process block 120-8. If affirmative, then an answer is sought to the query “Is event ready to encode?” at decision diamond 120-10. If negative, the necessary waiting occurs until an event is ready to encode block 120-14. If affirmative, then at process block 120-16, the file content source for annotaton is selected. Then, at process block 120-20, event data for annotations is gathered. Typical event data for sporting events would include sports specific information, such as types of athletic plays, historical events related to sporting events, and general sports related regarding statistics. Events other than sports may also be gathered for annotations. Upon information gathering, encorder queuing block 120 is completed and exits to process block 132.

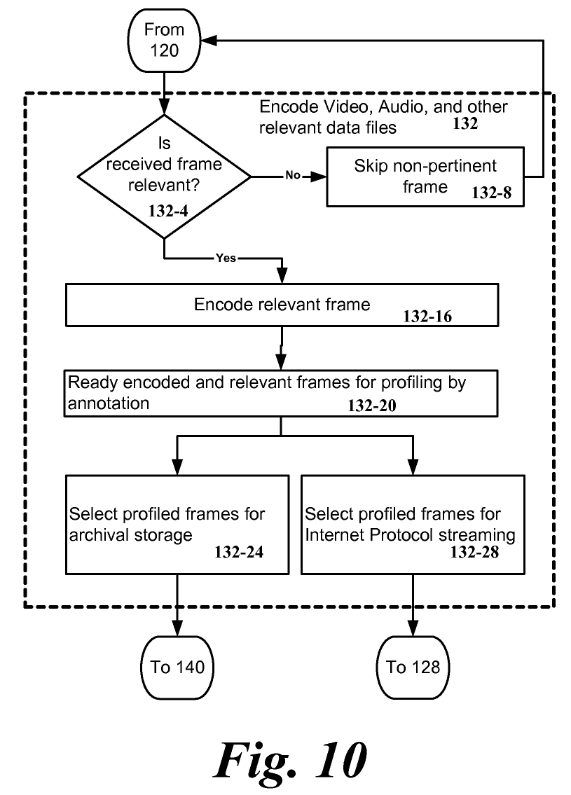

FIG. 10 schematically illustrates an expansion of the video and data encoding block 132 of FIG. 5. Entering from process block 120, an answer is sought to the query “Is received frame relevant?” at decision diamond 132-4. If negative, for example commercials are present or other subject matters considered non or not pertinent to the sporting event or event defined to be relevant, the frames or frames are skipped and process block 132-8 returns to process block 120 for reentry into process block 132. If affirmative for relevant or pertinent frame or frames, then at process block 132-16, the relevant frames or frames are encoded. Thereafter, at process block 132-20, the encoded and relevant frames are readied for profiling by annotation. The frames declared to be ready for annotation profiling are partitioned to those destined for archival storage at process block 132-24, or those frame or frames selected or destined for Internet Protocol streaming at process block 132-28. If destined for archival storage at process block 132-24, process block 132 exits to process block 140. If destined for Internet Protocol stream at process block 132-28, process block 132 exits to process block 128.

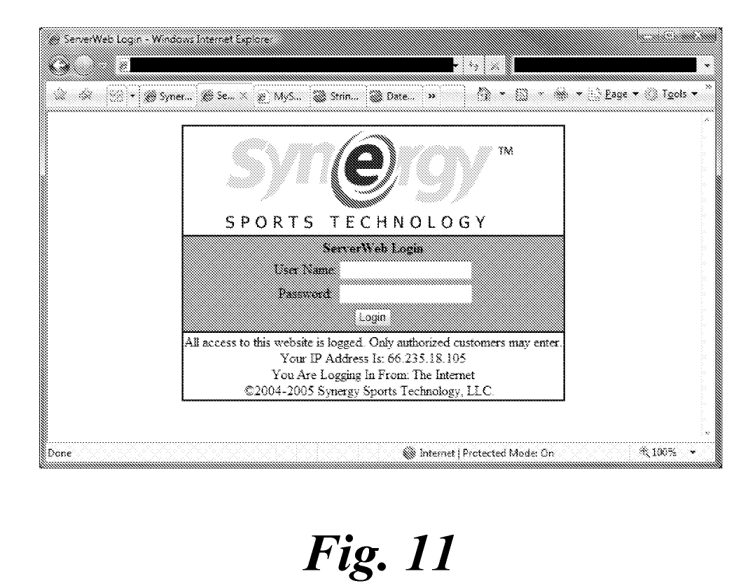

FIGS. 11-21 depict various screenshots used in executing or resulting from the algorithms described in FIGS. 4-10.

FIG. 11 is an opening screenshot for the Synergy™ Sports Technology log-in page. Annotators or clients 50 enter their name and passwords for communication via the algorithms described in FIGS. 4-11 with the server 12 operating the heretofore described algorithms.

FIG. 12 is a screenshot of a master schedule web page. The master schedule page allows setup of game events and pre-allocation of human annotation resources and system operations.

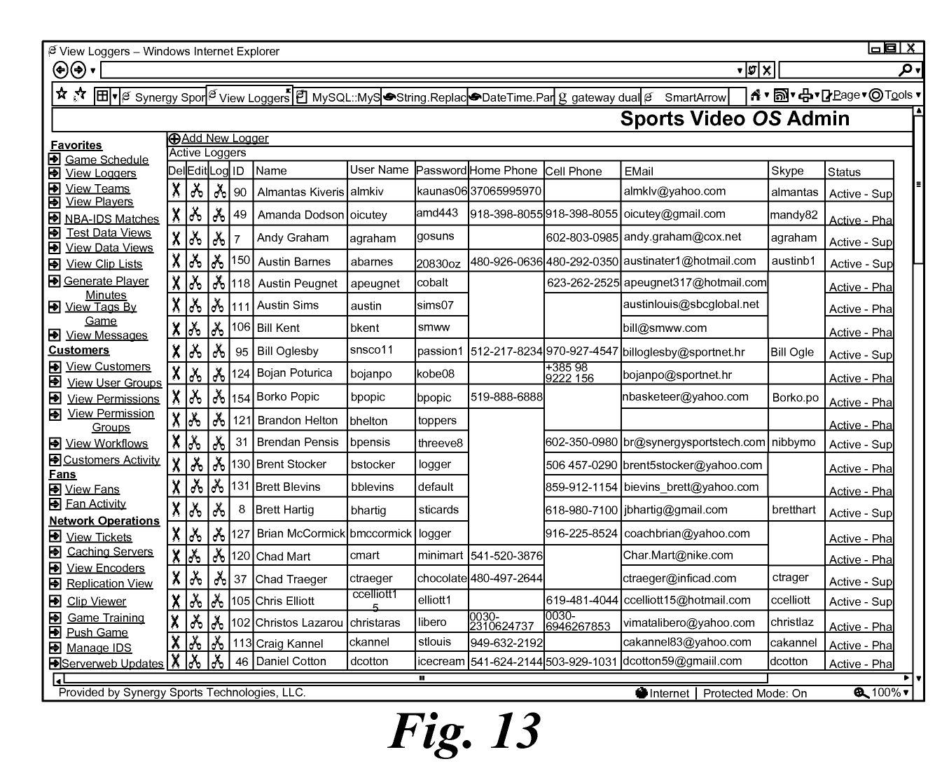

FIG. 13 is a screenshot of a resource manager. The resource manager presents a view of the system which allows operations to add/modify/delete human annotators to or from the annotation labor pool and other resources as well. Categorization or assignment of skill levels within the annotation labor pool and other associated information is presented for each person available to perform annotation tasks. This data allows the workflow engine to understand who is available and what they are certified for. The system also monitors who is logged in, their current bandwidth at that time as well as manages their own personal work queue.

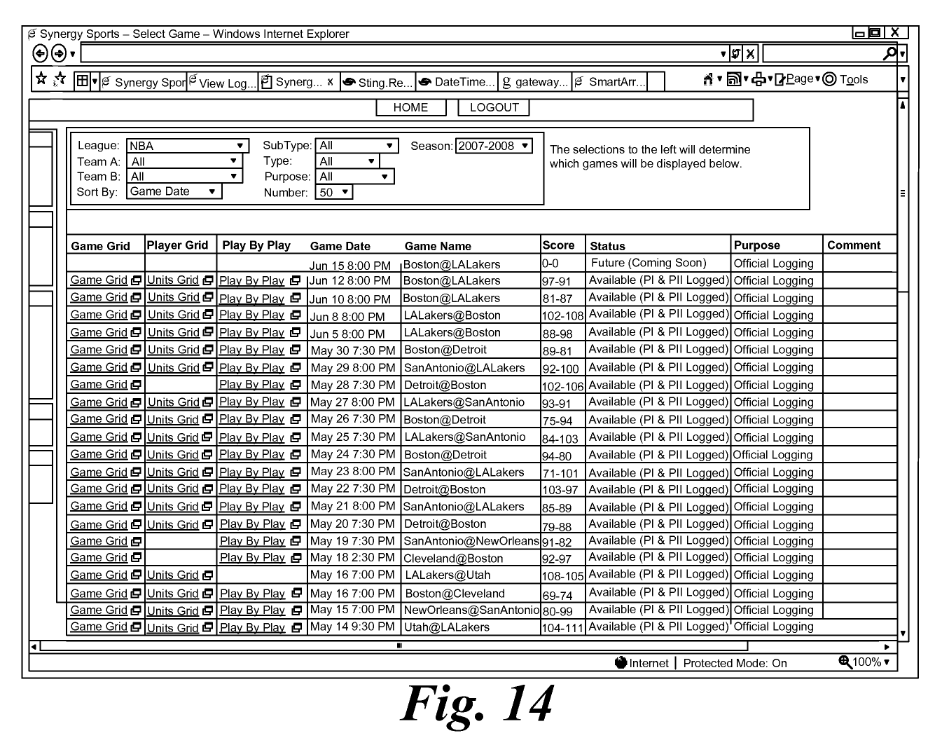

FIG. 14 presents a screenshot of an annotator's view of the product showing each game that has been logged and the current real-time status.

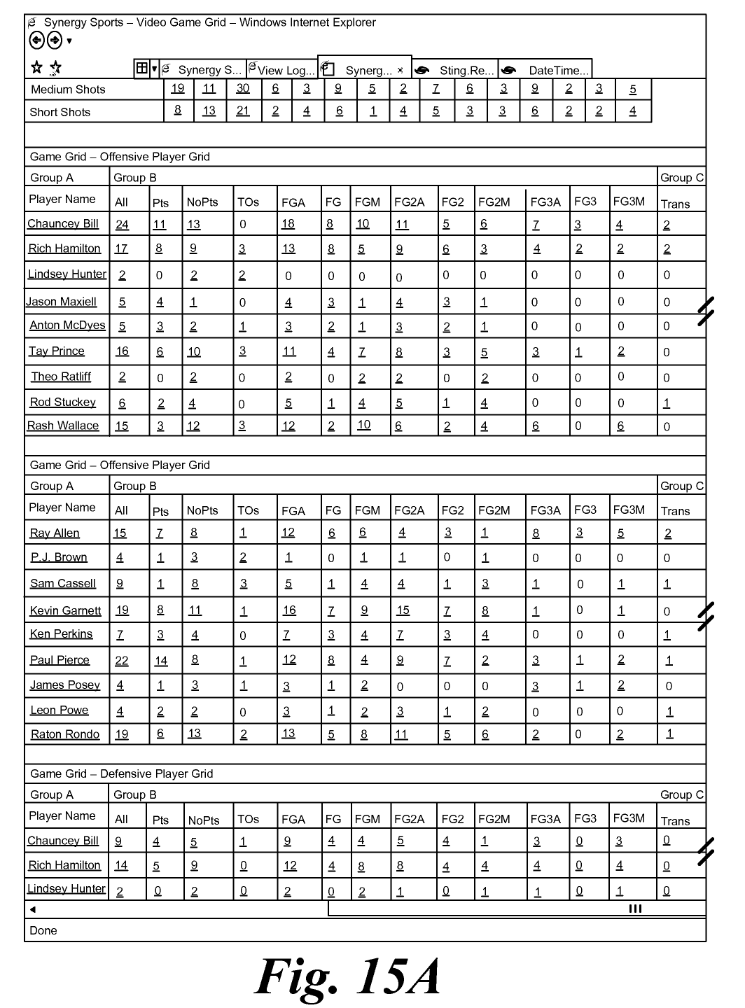

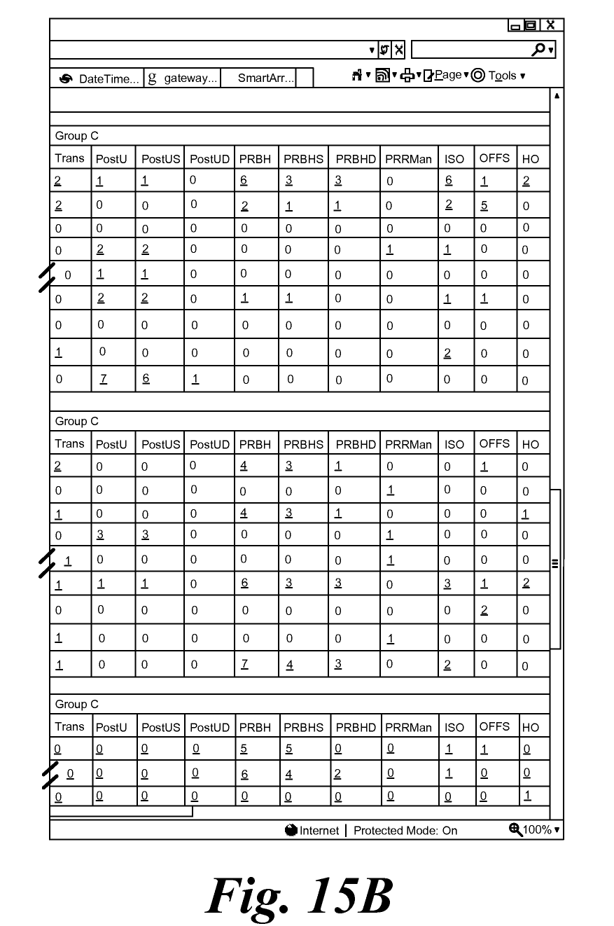

FIGS. 15A and 15B are partial portions of a screenshot that collectively provides an example the amount of data generated by the Synergy logging methodologies for a single game. This represents only a summary of what is logged yet contains multiples of the data otherwise available from any other system or source confined to providing on-site low annotation level services.

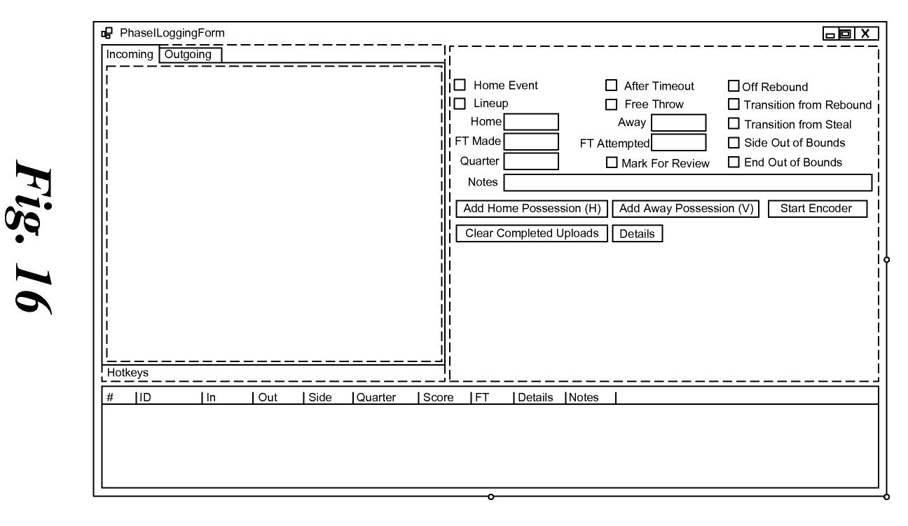

FIG. 16 is a screenshot illustrating a fast way to record sports specific statistics of an annotator remotely viewed sporting event. As illustrated are examples of a annotator level-1 or phase I sports event logging forms. The annotator level-1, once after logged into the Synergy™ Sports Technology system, are synchronized with the core workflow and media flow engines described in FIGS. 4-10 above. Essentially there is an incoming and outgoing work queue which is managed by their own personal client and server side queue managers, both of which work with the workflow engine and the media engine to get schedule new units of work and to increase the overall progress of work being performed. If a client goes offline they can still perform work and their results will remain in an outgoing queue until they return online. In this screenshot, basketball related information pertaining to time of possession, transitioning from a steal or a rebound, and engagable push-button tools for easy classification of categorical information is provided to the level-1 annotator.

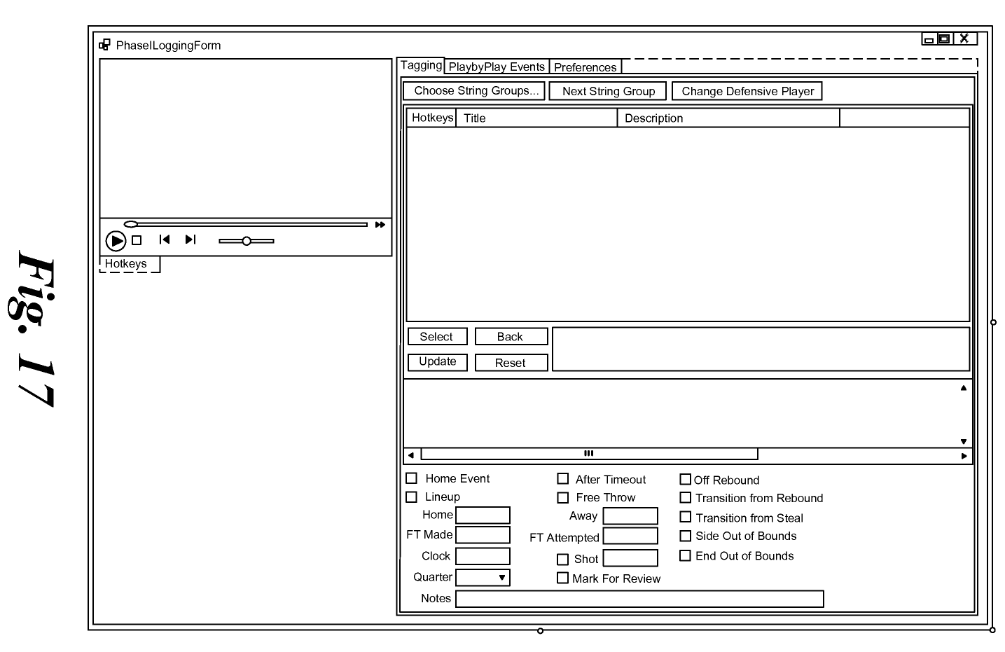

FIG. 17 is a screenshot illustration of main dialogs used by Phase II logging of an annotator level-2 worker. Notice that it is more sophisticated than the Phase I dialog as it requires more skill and it also presents more unique data per unit of output performed by Phase I in that the information is less categorical. That is the level of information provided by the level-2 annotation working is more open to statement creation or offering commentary.

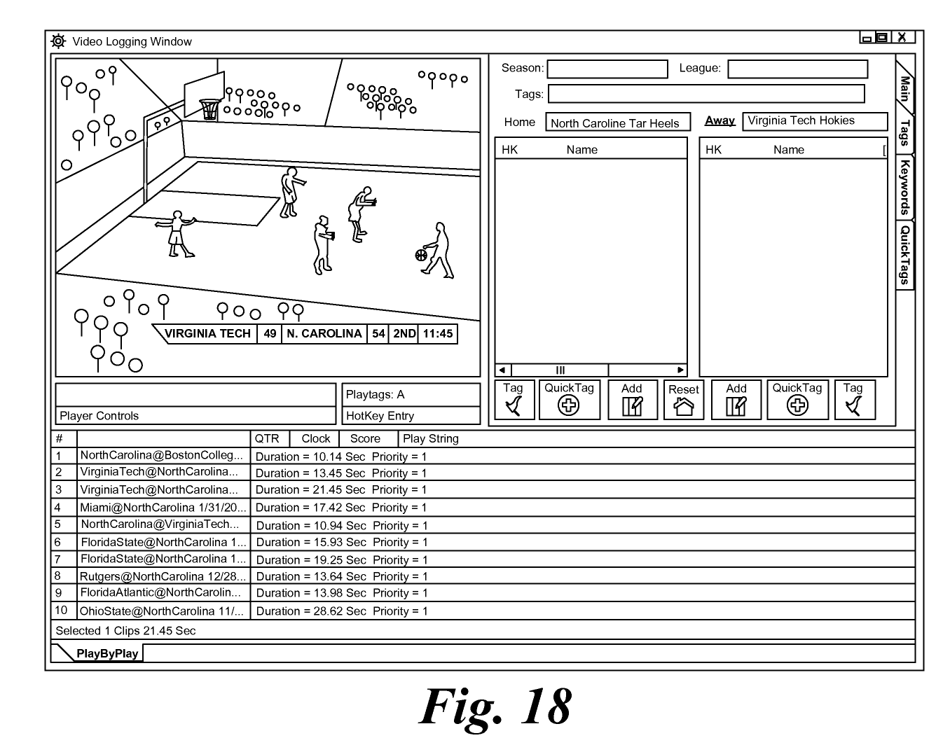

FIG. 18 provides a screenshot depicting operations of the logging software that shows a grid at the bottom reflecting the work which has been performed by each phase of the logged on annotators. The two list boxes allows fast logging of home or away game data depending on a selected ontology corresponding to the league, season, etc.

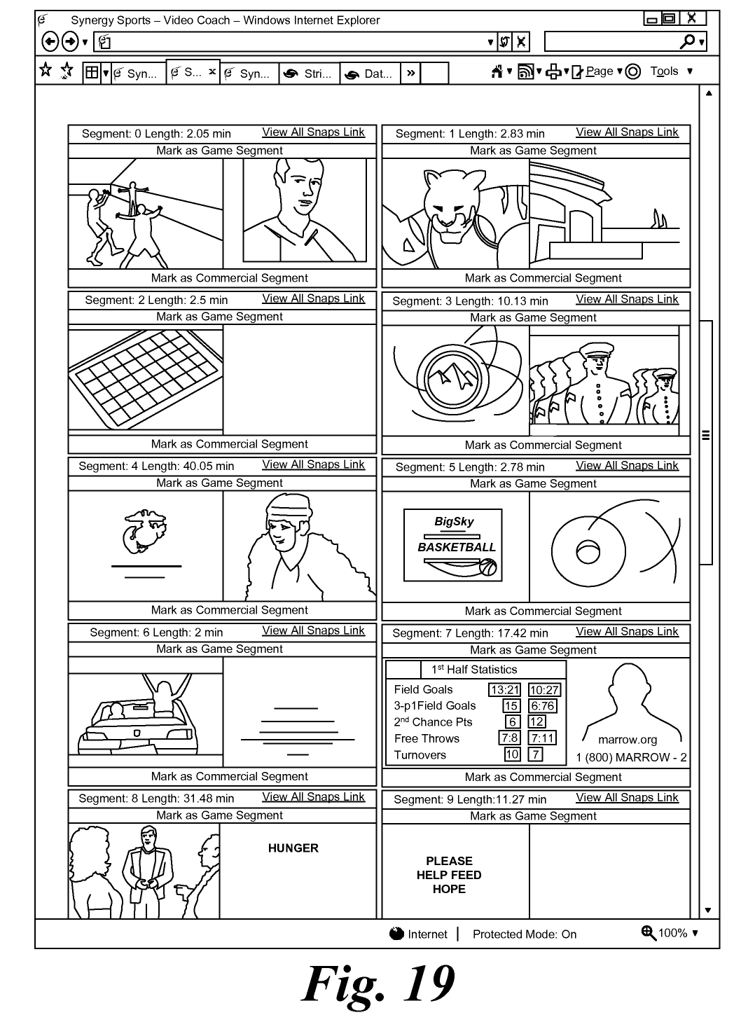

FIG. 19 depicts a screenshot having results of an automated portion of the media engine encoding system. Each set of pictures above bound video which is auto-guessed to contain only commercial (or other non-basketball time) or only useful game time. If unsure a unit of work can be queued in the system to finalize the choices made.

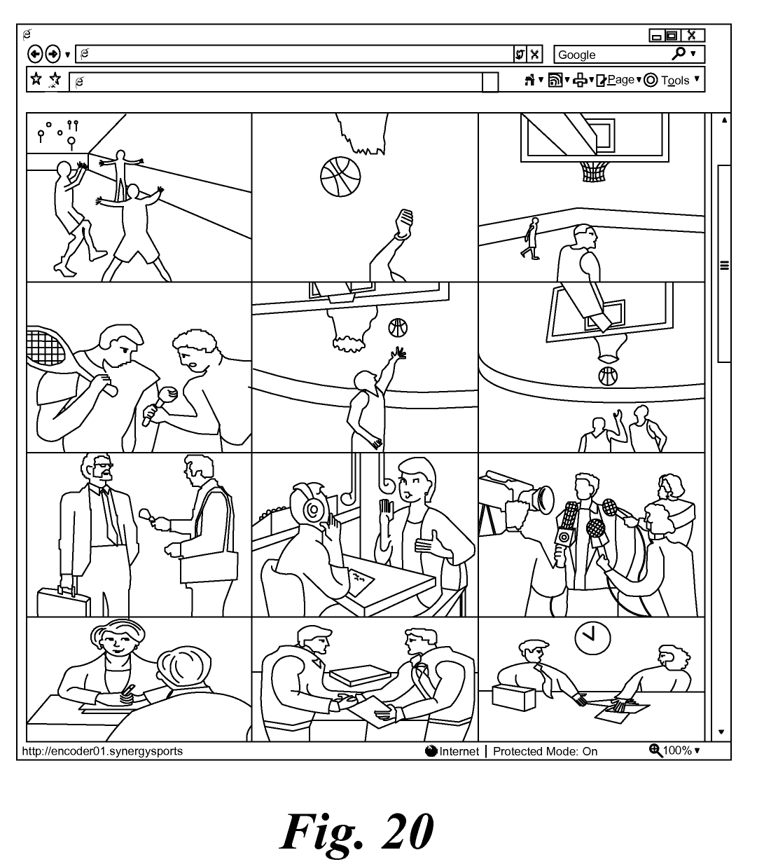

FIG. 20 depicts another high-information screenshot to allow any of the annotators in the skilled annotation pool to quickly scan a segment of a view panel and acquire snap shots to qualify game time or no-game time faster than it would take to actually review the video. Additionally this can be performed with very low bandwidth connections and remotely as illustrated by example in the pictograph of FIG. 2.

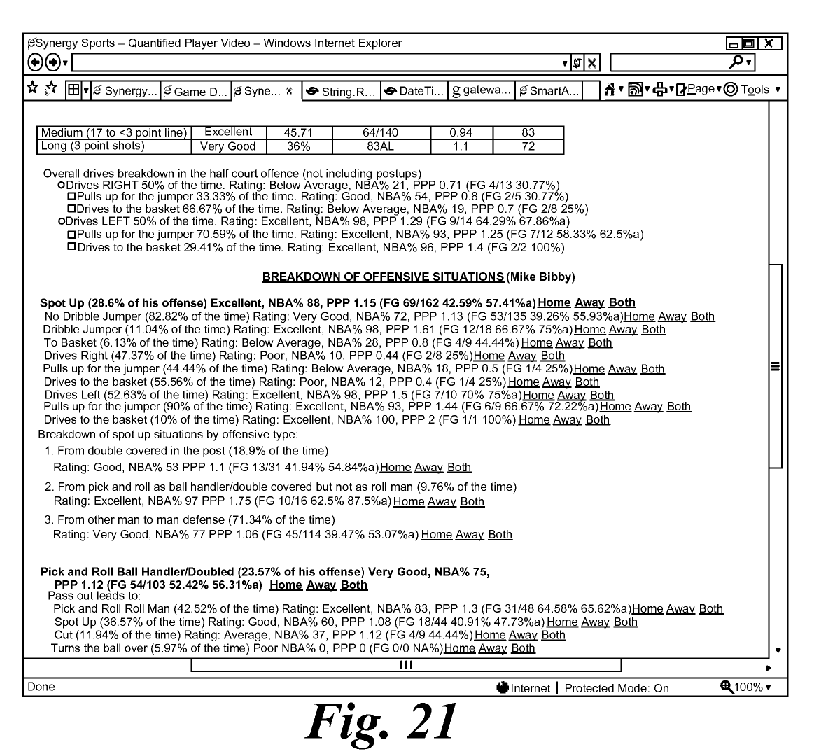

FIG. 21 is a portion of a screenshot having a view output based on the results of the algorithms described for FIGS. 4-10. This level of detail is generated at reasonable costs utilizing the annotation methods of the algorithms discussed above. A rapidly acquired high-information annotation content of broadcast events is remotely acquired by the pool of skilled annotators on call and hooked in communication via the algorithms provided by the Synergy™ Sports Technology system.

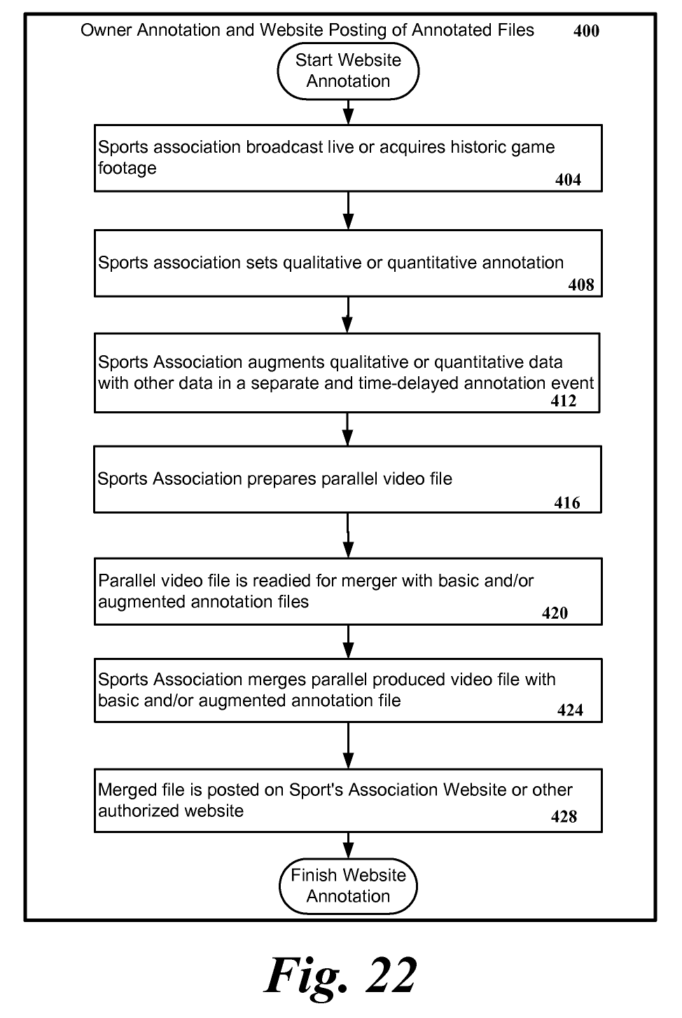

FIG. 22 illustrates another particular embodiment for an owner annotation method 400 and positing of owner-annotated files for public viewing on an owner website or other authorized website. The owner, or example a sports association owner of a team or authorized licensor of same, many employ the owner annotation algorithm 400. The owner algorithm 400 may also be referred to as a website annotation algorithm 400. Algorithm 400 begins with process block 404 where a sport association, team owner, or team licensee receives live broadcasts or retrieves or otherwise acquires historic game footage from archival storage. Thereafter, at process block 408, the sports association applies or sets qualitative and/or quantitative annotation of basic sports-related statistics to the live or historic file footages. At process block 412, the basic qualitative and/or quantitative annotations are combined or enhanced with other annotations in a separate and time-delayed annotation event. Then, the sports association may prepare a parallel video file at process block 416, which is then readied for merger with the basic and/or augmented annotation files at process block 420. The sports association then merges the parallel produced video file with the basic and/or augmented annotation file at process block 424. The merged file or files, at process block 428, is/are then posted on the Sport's Association or owner website or other owner-authorized website on a server for public access via the Internet or other network for public viewing. Upon website posting, the algorithm 400 is complete.

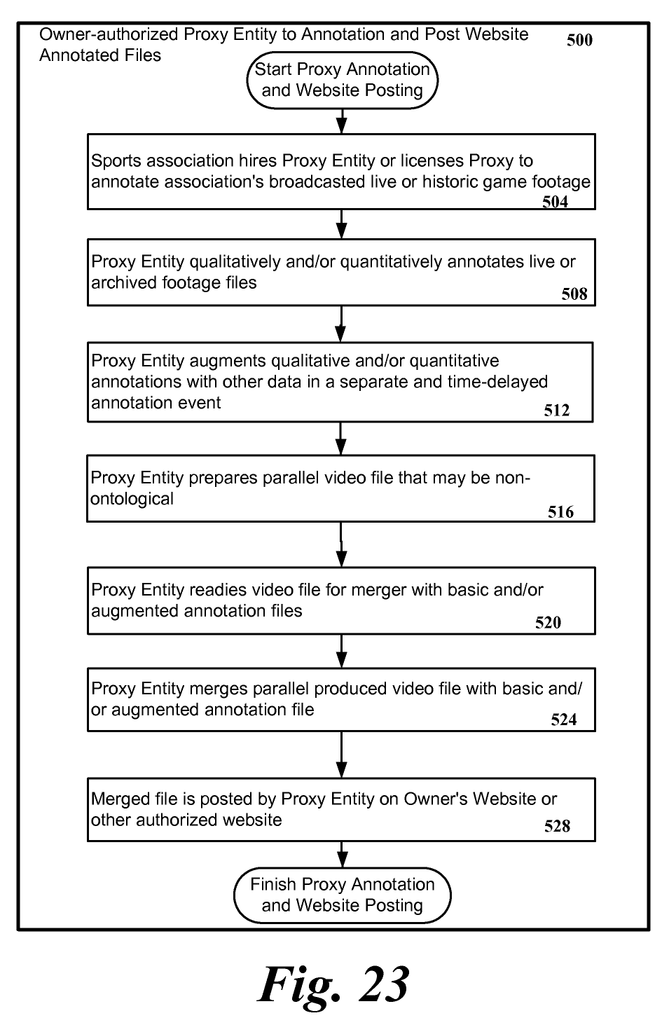

FIG. 23 illustrates yet another particular embodiment for video file annotation method 500 applied to an employer or owner-authorized Proxy Entity. The annotation method 500 employs a Proxy Entity working under the authority of or in agreement with an owner, for example a sports association or other broadcast content owner or licensor. The owner allows or hires the Proxy Entity to annotate and post owner-provided image or data files for public viewing on a public server, either on the owner's website, the Proxy Entity's website, or other authorized website.

The Proxy Entity algorithm 500 may also be referred to as a Proxy Annotation and website annotation algorithm 500. Algorithm 500 begins with process block 504 where a sport association, team owner, or team licensee receives hires a Proxy Entity or licenses the Proxy Entity to annotate the sport association's broadcasted live or historic game footage. Thereafter, at process block 508, the Proxy Entity applies or sets qualitative and/or quantitative annotation of basic sports-related statistics to the live or historic file footages. At process block 512, the basic qualitative and/or quantitative annotations are combined or enhanced with other annotations in a separate and time-delayed annotation event. Then, the Proxy Entity may prepare a parallel video file at process block 516, which is then readied for merger with the basic and/or augmented annotation files at process block 520. The Proxy Entity then merges the parallel produced video file with the basic and/or augmented annotation file at process block 524. The merged file or files, at process block 528, is/are then posted on the Sport's Association or owner website, the Proxy Entity's website, or other owner-authorized and/or Proxy-authorized website on a server for public access via the Internet or other network for public viewing. Upon website posting, the algorithm 500 is complete.

While the particular embodiments have been illustrated and described for acquiring efficient annotations of live and archived footages or data files, other embodiments may include deriving time and positional information from signals received from radiofrequency identification (RFID) tags worn by players during competitions and used to annotate broadcast file footages of the positions of players during or immediately after a sporting event, or applied to archival files of a sporting event. The time and positional information derived from the player-adorned RFID tags, or adorning a horse or affixed to an automobile in a racing or other competition, may be acquired from the RFID tags or other non-video sources or video sources and inputted to the Media Engine Algorithm 200 to provide vector-based three-dimensional annotative information of the competitive event. Accordingly, the scope of the invention is not limited by the disclosure of the preferred embodiment. Instead, the invention should be determined entirely by reference to the claims that follow.

The embodiments of the invention in which an exclusive property or privilege is claimed are defined as follows:

1. A method for video editing comprising:
importing at least one of an analog and a digital media from a video source;
transcoding the at least one analog and at least one digital media to form a transcoded media;
acquiring an annotation service;
uploading the transcoded media to a server;
reviewing the transcoded media on a client device; and
annotating at least a portion of the transcoded media using the annotation service.

2. The method of claim 1, wherein annotating includes posting an annotated portion of the transcoded media on a public accessible website.

3. The method of claim 2, wherein posting the annotated portion is viewable by the public accessing the public accessible website.

4. The method of claim 1, wherein acquiring the annotation service includes recruiting an on-line labor pool having definable annotation repertoires.

5. The method of claim 4, wherein recruiting includes confirming the availability of the on-line labor pool for assigning annotation duties.

6. The method of claim 5, wherein assigning annotation duties includes partitioning into the definable annotation repertoires.

7. A system for video editing comprising:
a media engine to import at least one of an analog media and a digital media, and to transcode the analog and digital media to form a transcoded media file;
a server for receiving the transcoded media file;
an annotation service available to annotate at least a portion of the transcoded media file; and
a workflow engine utilizable by the annotation service to annotate the portion of the transcoded media file to form an annotated media file.

8. The system of claim 7, wherein the annotated media file is stored on the server.

9. The system of claim 8, wherein the annotated media file is accessible by the public.

10. The system of claim 9, wherein the annotated media file accessible by the public is viewable by the public.

11. The system of claim 7, wherein the annotated media file include Windows Media and MPEG 4.

12. The system of claim 11, wherein the server matches image segments of the annotated media file with video segments.

13. The system of claim 7, wherein the annotation service reviews and configures the transcoded media file to be responsive to commands from a user.

14. The system of claim 14, wherein the commands are sent to the media engine to create media elements from a video archive extractable from the server.

15. The system of claim 14, wherein the media elements include fast forward, play, pause, stop, and fast reverse keys.

16. The system of claim 7, wherein the digital media include video-on-demand for at least one of a live digital video file and a stored digital video file.

17. The system of claim 16, wherein the live digital video file and the stored digital video file are deliverable to the annotation service upon request by the annotation service.

18. The system of claim 7, wherein the workflow engines manages the delivery of the transcoded media file.
